(19) United States
(12) Patent Application Publication
(10) Pub. No.: US 2020/0387868 A1
(43) Pub. Date: Dec. 10, 2020

(54) SYSTEMS AND METHODS FOR TARGETED DISTRIBUTION ITEM DELIVERY

(71) Applicant: United States Postal Service, Washington, DC (US)

(72) Inventors: Robert E. Dixon, JR., Haymarket, VA (US); Scott R. Bombaugh, Burke, VA (US)

(21) Appl. No.: 16/892,002

(22) Filed: Jun. 3, 2020

Related U.S. Application Data
(60) Provisional application No. 62/857,079, filed on Jun. 4, 2019.

(51) Int. Cl. G06Q 10/08; G06Q 30/02; G06Q 30/00; G06K 7/14

(52) U.S. Cl. CPC G06Q 10/08355; G06Q 30/0205; G06K 7/1413; G06Q 30/0185; G06Q 10/0833

(57) ABSTRACT

Systems and methods for sending targeted items in a delivery network. Items can be targeted to geographical areas or routes based on attributes or criteria of the delivery points in the geographical areas or routes.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority to U.S. Provisional Application No. 62/857,079, filed Jun. 4, 2019, the entire contents of which are hereby incorporated by reference.

### BACKGROUND

This disclosure relates to delivering a plurality of identical or similar items, such as saturation mail, to a plurality of destinations within a specified geographic area.

### SUMMARY

In one aspect described herein, a method for processing items, the method comprises receiving, via a user interface, information identifying a campaign for distributing a plurality of items; receiving, via the user interface, an indication of a geographic area to which the plurality of items will be delivered; receiving, via the user interface, one or more selection criteria; determining one or more delivery routes within the geographic area which meet the one or more selection criteria; receiving a selection a plurality of delivery points from the one or more delivery routes to receive the plurality of items; storing the selected plurality of delivery points; receiving, in item processing equipment, one of the plurality of items; scanning, in the item processing equipment, the one of the plurality of items to identify the one of the plurality of items as being associated with the campaign; identify one of the selected plurality delivery points to receive the one of the plurality of items; sorting, in the item processing equipment, the one of the plurality of items according to the identified one of the plurality of delivery points; and updating tracking information for the stored selected plurality of delivery points.

In some embodiments, the plurality of items are identically addressed.

In some embodiments, the plurality of items do not have individual delivery points indicated thereon.

In some embodiments, the method further comprises receiving, via the user interface, a threshold value for the one or more selection criteria.

In some embodiments, the method further comprises generating a unique identifier to identify the plurality of items of the campaign.

In some embodiments, wherein scanning the one of the plurality of items to identify the one of the plurality of items as being associated with the campaign comprises reading the unique identifier from the received one of the plurality of items.

In some embodiments, the method further comprises, determining, in a processor, a drop location for the plurality items.

In some embodiments, the drop location is a facility where a sender of the plurality of items physically provides the plurality of items to be inducted into a distribution network.

In some embodiments, determining a drop location comprises determining a plurality of drop locations based on the selected geographic area and the determined one or more delivery routes.

In some embodiments, the method further comprises displaying, via the user interface, the determined one or more delivery routes

In some embodiments, the selected plurality of delivery points from the one or more delivery routes include each delivery point for each of the one or more delivery routes.

In some embodiments, the selected plurality of delivery points from the one or more delivery routes include only a subset of delivery points from each of the one or more delivery routes.

In another aspect described herein, a method for securing a receptacle comprises receiving, in a processor, campaign information for distribution of a plurality of items, the campaign information including a plurality of delivery points to receive the plurality of items of the campaign; receiving, in item processing equipment, one of the plurality of items; scanning, in the item processing equipment, the one of the plurality of items to identify the one of the plurality of items as being associated with the campaign; identifying, by a processor, one of the plurality of delivery points from the campaign information; assigning, in a memory, the scanned item to the identified one of the plurality of delivery points; moving, in the item processing equipment, the scanned item to a sort location according to the assigned delivery point; and updating a tracking record for the campaign information based on the moving the scanned item to the sort location according to the assigned delivery point.

In some embodiments, the campaign information includes delivery point records for each delivery point of the plurality of delivery points.

In some embodiments, updating a tracking record for the campaign information comprises updating the delivery point record to indicate that the scanned item of the plurality of items has been assigned to the delivery point.

In some embodiments, the plurality of items are identically addressed.

In some embodiments, the plurality of items do not have individual delivery points indicated thereon

In another aspect described herein, a system for processing items comprises a server configured to receive, via a user interface, information identifying a campaign for distributing a plurality of items; receive, via the user interface, an indication of a geographic area to which the plurality of items will be delivered; receive, via the user interface, one or more selection criteria; determine one or more delivery routes within the geographic area which meet the one or more selection criteria; display, via the user interface, the one or more delivery routes which meet the one or more selection criteria; receive, via the user interface, a selection a plurality of delivery points from the one or more delivery routes to receive the plurality of items; and store the selected plurality of delivery points; item processing equipment configured to: receive, in item processing equipment, one of the plurality of items; scan, in the item processing equipment, the one of the plurality of items to identify the one of the plurality of items as being associated with the campaign; identify one of the selected plurality delivery points to receive the one of the plurality of items; and sort the one of the plurality of items according to the identified one of the plurality of delivery points.

In some embodiments, the plurality of items are not individually addressed.

### BRIEF DESCRIPTION OF THE DRAWINGS

FIG. 1 is a block diagram of an embodiment of a system for coordinating a targeted item delivery in a distribution network.

FIG. 2 is an exemplary view of a graphical user interface for interacting with a distribution network.

FIG. 3 is a flow chart illustrating an exemplary method for preparing saturation items for distribution.

FIG. 4 is a flow chart illustrating an exemplary process for processing saturation items.

### DETAILED DESCRIPTION

An item distribution network, such as the United States Postal Service (USPS) can deliver to a plurality of destinations each day. A distribution network may comprise multiple levels, any one of, or each of which may utilize linear actuators in a flats sequencing system. For example, a distribution network may comprise regional distribution facilities, hubs, and unit delivery facilities, or any other desired level. Each of these facilities may utilize flats sequencing systems in order to properly sort and distribute items as required en route to delivery to a final destination. For example, a nationwide distribution network may comprise one or more regional distribution facilities having a defined coverage area (such as a geographic area), designated to receive items from intake facilities within the defined coverage area, or other regional distribution facilities. The regional distribution facility can sort items for delivery to another regional distribution facility, or to a hub level facility within the regional distributional facility's coverage area. A regional distribution facility can have one or more hub level facilities within its defined coverage area. A hub level facility can be affiliated with a few or many unit delivery facilities, and can sort and deliver items to the unit delivery facilities with which it is associated. In the case of the United States Postal Service, the unit delivery facility may be associated with a ZIP code. The unit delivery facility receives the items, sorts and stages the items for delivery to the destinations within the unit delivery facility's coverage area.

The distribution network delivers items that are intended for delivery to specific recipients or destinations, which can be indicated by an identifier, such as an address, on the item. The distribution network can also deliver bulk or saturation items, which are not specifically addressed to recipients, but are intended for delivery to each location or delivery point along a route or within a geographic area. In the case of the USPS, such items may be referred to as Every Door Direct Mail® (EDDM). However, a piece of saturation mail or EDDM may not be relevant to or of interest to a recipient at every delivery point to which it is delivered. This can result in wasted material, time, and cost. Using known preferences and prior item delivery history, a distribution network can target items to geographic areas, routes, etc. which have expressed an interest, preference for, or meet demographic criteria relevant to the goods and/or services described in the saturation mail.

In order to provide the most relevant items to a recipient, a mailer or other item sender can request that the distribution network provide demographic or preference information for delivery points or geographic areas which meet criteria or which have demonstrated an interest relevant to a target identified by the mailer or item sender. The distribution network can provide an interface to allow a mailer or sender to identify geographic areas, such as ZIP codes, carrier routes, etc. which meet criteria, can provide an estimated number of pieces, the number of drop locations, and a cost per piece and a total cost. The distribution network can also provide or receive a computer readable code associated with the item and the campaign.

Currently, saturation mail or EDDM is dropped at or provided to unit delivery facilities, such as post offices, in bulk, such as on a pallet, in a container, etc., and is not sorted or pre-sorted. Saturation mail or EDDM is not processed into route sequence by item processing equipment. Rather, carriers manually insert saturation mail or EDDM into the trays or stacks for each delivery point along the carrier's route. It would be advantageous to insert EDDM into the delivery sequence order on the item processing equipment according to the sort plan, and then be sorted into a carrier's route. The distribution network can select a facility at which to receive the EDDM items, which need not be, but could be, a unit delivery facility, and can instruct the item processing equipment at that facility to sort accordingly. The item processing equipment creates logical handling events for each destination or address along a route for which mail is being sorted. The logical handling event corresponds to a piece of EDDM being sorted to each destination on the mail processing equipment, and allows the distribution network to track and provide analytics data for the EDDM mailing.

As EDDM items are delivered, logical handling events are generated corresponding to known handling events for addressed items, such as mail or parcels. The logical handing events, handling event time, location, and other information can be collected, aggregated, analyzed, and provided to the sender or mailer of the EDDM items. Service performance measurement analytics are performed, and the analytics information is used to provide future estimated delivery times, drop locations, route information, predict future costs for EDDM, or for any other desired purpose. This will be described in greater detail herein.

Although the term EDDM is used throughout the specification, a person of skill in the art will understand, guided by this disclosure, that this term is exemplary and not limiting, and that this disclosure can include other types of items, saturation mail, etc.

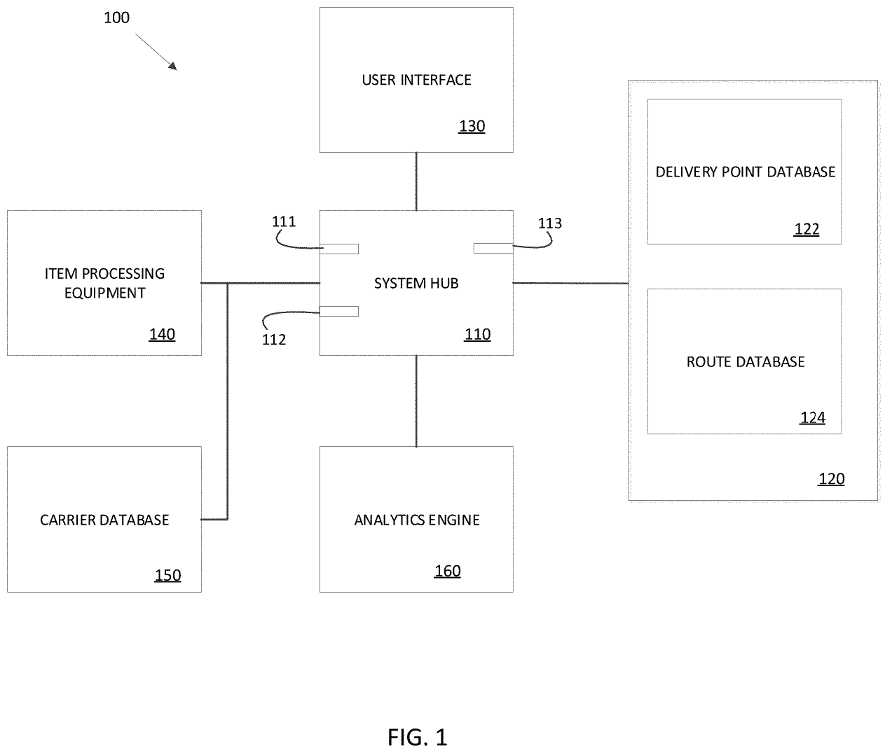

FIG. 1 is a block diagram illustrating an embodiment of a system 100 for managing targeted item delivery. The system 100 comprises a system hub 110. The system hub may comprise or be a component of a processing system implemented with one or more processors. The system hub 110 may be a network of interconnected processors housed on one or more terminals. The one or more processors may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that may perform calculations or other manipulations of information. The system hub 110 may comprise a processor 111 such as, for example, a microprocessor, such as a Pentium® processor, a Pentium® Pro processor, a 8051 processor, a MIPS® processor, a Power PC® processor, an Alpha® processor, a microcontroller, an Intel CORE i7 i5®, or i3® processor, an AMD Phenom®, A-series or FX® processor, or the like. The processor 111 typically has conventional address lines, conventional data lines, and one or more conventional control lines. The processor 111 may be in communication with a processor memory 112, which may include, for example, RAM memory, flash memory, ROM memory, EPROM memory, EEPROM memory, registers, hard disk, a removable disk, a CD-ROM, or any other form of storage medium known in the art. The processor memory 112 may include, for example, software, at least one software module, instructions, steps of an algorithm, or any other information. In some embodiments, the processor 111 performs processes in accordance with instructions stored in the processor memory 112.

The system hub 110 comprises a system memory 113 configured to store information, such as program instructions and the like. The system memory 113 may comprise a database, a comma delimited file, a text file, or the like. The system hub 110 is configured to coordinate and direct the activities of the components of the system 100.

In some embodiments, the system hub 110 is in communication with a memory 120. In some embodiments, the memory 120 may comprise a processor, memory, databases, address and control lines, and other components similar to those described herein for the system hub 110. In other embodiments, the memory 120 may be configured to use the processor, memory, databases, address and control lines, and other components of system hub 110, or a combination of its own components and the system hub 110's components.

The memory can include a delivery point database 122 and a route database 124. The delivery point database 122 can store information regarding items delivered to delivery points in the distribution network, preferences for residents, demographic information, item delivery history, etc. for delivery points in the distribution network. The delivery point database 122 can assign a demographic value or preference category to each delivery point based on census information, prior order history, identifiers of items received, such as credit card bills, utility bills, bank information, etc., tax information, and the like. The delivery point database 122 can be similar to the household database or other databases of the USPS. The distribution network can categorize delivery points according to specific attributes, such as preferences, demographics, etc., and can generate a hierarchy of preferences, including associating each delivery point with preference categories and/or subcategories within the hierarchy, or associating the delivery points with specific attributes.

The attribute information can be obtained in a variety of ways. A recipient, such as a postal customer, may select or provide delivery preferences to a distribution network, which include preferences for types of items to receive. These preferences can be stored in a customer profile for each customer or delivery point. The profile can store preferences for delivery, customer interests or categories of interests, permissions for gathering information and data, In some embodiments, a recipient can opt-in to a system for gathering preference information based on items delivered to the recipient. In some embodiments, the USPS can gather information regarding items received at a residence or by a resident through its distribution network. The USPS may also identify that a residence or more than one residence within a geographic area requests or receives specific periodicals, advertisements, deliveries, or other items. Additionally, since most items likely include a resident to which they are destined, the USPS may correlate the delivery point receiving a specific item with the resident identified as being the recipient of the item. Thus, the USPS may generate associations between residents and the delivery points to which the USPS delivers and these associations are stored in the delivery point database 122.

In some embodiments, the item delivery service may be able to identify residents that have specific associations or receive item(s) that meet specific requirements. Thus, the distribution network can gather, analyze, and provide that information to third parties that may wish provide goods, services, marketing material, etc. relevant to the attributes and associations identified for recipients in the distribution network. Such information may allow the third parties to perform targeted marketing campaigns, where advertisements and/or promotional materials are only sent to those residents identified as having an interest in the third parties goods or services, as determined by having previously received an item associated with the goods or services. Additionally, the item delivery service may be able to identify resident behavioral trends and preferences, based on the analysis of previously received items.

The delivery point database 122 may identify and gather information from items that are distributed using the distribution system described above, and can use the information gathered to identify trends, habits, general preferences, life events, etc., of the residents and entities that send and receive the items via the item delivery service. The identified trends, habits, preferences, events, etc., may then be used to identify, generate, and allow third party access to a preference system or hierarchy, including attribute designations. In some embodiments, the delivery point database 122 can identify, based on information gathered information received from a temporary forwarding service, that a resident is planning a vacation to a particular destination for a specified amount of time. In some embodiments, the identified trends, habits, preferences, etc., may be stored in the delivery point database 122 such that the related information is properly associated with delivery points in the delivery point database 122. A recipient may be associated with more than one delivery point, for example, with a residence and with a commercial or business address. In such a case, frequent or routine shipments from a commercial address to a residence may be identified as paychecks or paystubs, mortgage documents, credit card statements, bank statements, subscriptions, or other types of items based on the regularity of shipments and other associations.

Such other associations may include identifications that the resident of the delivery point has received an item at the commercial address from the same sender from which s/he has received at item at the residence. Additionally, or alternatively, the delivery point database 122 may identify the resident's interest in golfing based on identifying the resident having received multiple items or packages from golf companies or otherwise related to golf. In some embodiments, associations may be obtained from external sources (such as credit history companies) or directly from the residents themselves. In some embodiments, a resident may identify interests in a resident's account or surveys or similar methods of obtaining resident interests.

The system hub 110 uses the information in the delivery point database 122 to identify which delivery points meet criteria provided by mailers or shippers of items, such as EDDM. In some embodiments, the system hub 110 will not provide delivery point information, such as addresses to the mailer or shipper, but can provide route level information or another level of information. In some embodiments, the system hub 110 can associate a computer readable code with an EDDM mailing or campaign, and the code can be provided to the shipper or mailer.

The route database 124 stores assigned routes for carriers in the distribution network, including an identifier for each delivery point, a delivery point sequence, etc. for each route. The route database 124 can receive information from the delivery point database 124 regarding preferences and demographics, and can associate averaged or aggregated information on a route level. The route database contains a plurality of geographic areas, including ZIP codes, municipal boundaries, governmental borders, etc.

The system hub 110 is in communication with the delivery point database 122 and the route database 124, and can pull information from both in order to identify routes meeting criteria from a sender or mailer. This process will be described in greater detail below.

In some embodiments, the system hub 110 is in communication with a user interface 130. In some embodiments, the user interface 130 can be embodied in hardware or software, and can be accessible via a website or web application, a mobile computing device application, or any other desired means. The user interface 130 is accessible to a sender or a mailer, and provides a graphical interface for making requests to and receiving information from the system hub 110.

The system hub 110 is in communication with item processing equipment 140. The item processing equipment 140 can be one or more of an item sorter, facer, residual mail sorter, flats feeder, delivery bar code sorter (DBCS), or any other type of item processing equipment. The item processing equipment is able to scan items, image items, OCR item information, and sort items according to the scanned information. The item processing equipment can also include an injection feature configured to inject an item into a mail stream or a stream of items at intervals or for individual delivery points. In some embodiments, the item processing equipment 140 may comprise a processor, memory, databases, address and control lines, and other components item processing equipment 140 may be configured to use the processor, memory, databases, address and control lines, and other components of system hub 110, or a combination of its own components and the system hub 110's components.

The system hub 110 is in communication with a carrier database 150. The carrier database 150 may comprise a processor, memory, databases, address and control lines, and other components similar to those described herein for the system hub 110. In other embodiments, the carrier database 150 may be configured to use the processor, memory, databases, address and control lines, and other components of system hub 110, or a combination of its own components and the system hub 110's components.

The carrier database 150 stores or has access to information regarding carrier activities, including pick-up events, delivery events, and the like. The carrier database 150 can receive and store information indicative of actual handling or delivery events as well as logical handling and delivery events. Carrier information, including location information, delivery times, etc. can be received in the carrier database 150 from a mobile delivery device (not shown) which is in wireless and/or wired connection with the carrier database 150. The carrier database 150 stores, among other data, carrier GPS breadcrumb data, delivery times, carrier route assignments, and the like.

The system hub 110 can provide information from the carrier database 150 to an analytics engine 160, which can perform analytics and diagnostics on service performance, delivery time requirements, percent delivery or saturation, and the like. The analytics engine 160 can determine what the delivery time was for any particular EDDM mailing or mailpiece. The analytics engine can use carrier breadcrumb data to provide a predictive model of when an item of EDDM may be delivered. The analytics engine can determine whether an EDDM mailing met a service class requirement, was delivered in a timely manner, or met a guaranteed delivery date and/or time. In some embodiments, the analytics engine can analyze how much time it took a carrier to complete a route when an EDDM mailing was present compared with how much time it took a carrier to complete a route when there the EDDM mailing was not present. The comparison can use several days, weeks, etc. worth of carrier information from the carrier database 150 to make these determinations. The increase in carrier route time, if any is found, can be used in part for calculating a cost for delivering EDDM.

The analytics engine 160 can also receive run time information or other item processing equipment information indicative of time spent processing EDDM items compared to processing items when EDDM items are not present. In some embodiments, the analytics engine 160 can receive raw data from the item processing equipment 140 and can determine how much additional time, effort, energy, etc. were required for running item processing equipment 140 with a EDDM mailpieces, and a can use this information to update or estimate a new cost for delivering EDDM mail pieces.

In some embodiments, the analytics engine 160 provides information to the interface 130 to a sender or mailer. The sender or mailer can get real-time, near real-time, or summary information regarding the location or delivery of the sender's or mailer's EDDM items. The sender or mailer can see an interactive map showing the location of EDDM pieces, as determined by data from the carrier database 150 and the route database 122, and can receive summary information regarding an EDDM mailing, such as a campaign, including delivery dates and times, percent delivery of items, and other information.

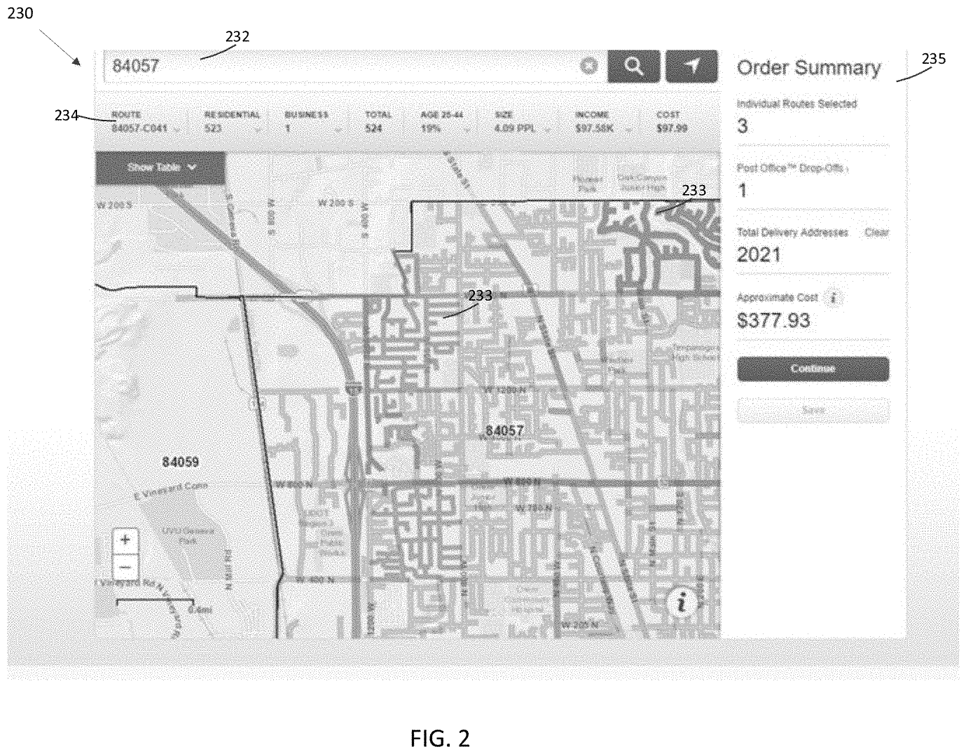

FIG. 2 depicts an exemplary view of a user interface 230. As shown, a sender, mailer, or other entity can request information about a geographic area, such as a ZIP code in a search field 232. Selecting a ZIP code or other area, for example, in search field 232, the interface can show a map of the selected ZIP code or area, such as that depicted in FIG. 2 A sender or mailer can select a route 233 from the displayed map. The user interface 230 can display route information provided by the system hub 110 as pulled from the memory 120. For each route, the system hub 110 can provide demographic information in the information bar 234 for each route 233. The demographic information can include the number of residential and commercial delivery points for each route, age information for residences, average income level, home ownership, and the like. In addition, the system hub 100 can provide preference information, which can be categorized in a hierarchy or other categorization method. For example, the user interface 230 can show, for each route 233, what percentage of delivery points own a home, rent a car, are interested in outdoor activities or sports, subscribe to a particular magazine, receive deliveries from a given sender or company, or any other information. This information is stored in the delivery point database 122. In some embodiments, the user interface 230 does not show information for individual delivery points out of concern for privacy, but aggregates the information, or shows anonymized or census-level, route-level, etc. information.

The user interface 230 can include the results of a request in a result field 235. The result field can show the number of routes 233 selected, a number of drop off locations and information specific to the drop-off locations, and an estimated cost for the items.

In some embodiments, the user interface 230 can receive specific requests from the user for a geographic area. A mailer can request information for or identification of delivery points that have specific demographic information or which meet certain attributes. For example, the mailer can upload or provide a number of preferences, demographic criteria, attributes, etc., and can request a particular percent threshold. The percent threshold can be a threshold percent of delivery points which meet the uploaded or provided preferences, attributes, demographic criteria, etc. The percent threshold can require that only routes that have a threshold percentage of delivery points meeting the provided preferences, attributes, demographic criteria, etc. will be provided.

The mailer can input criteria in the search field 232, or in another location. In some embodiments, the criteria can be input using a text string, and/or criteria can be selected from a list of criteria maintained by the distribution network. For example, a mailer may check one or more boxes regarding the criteria.

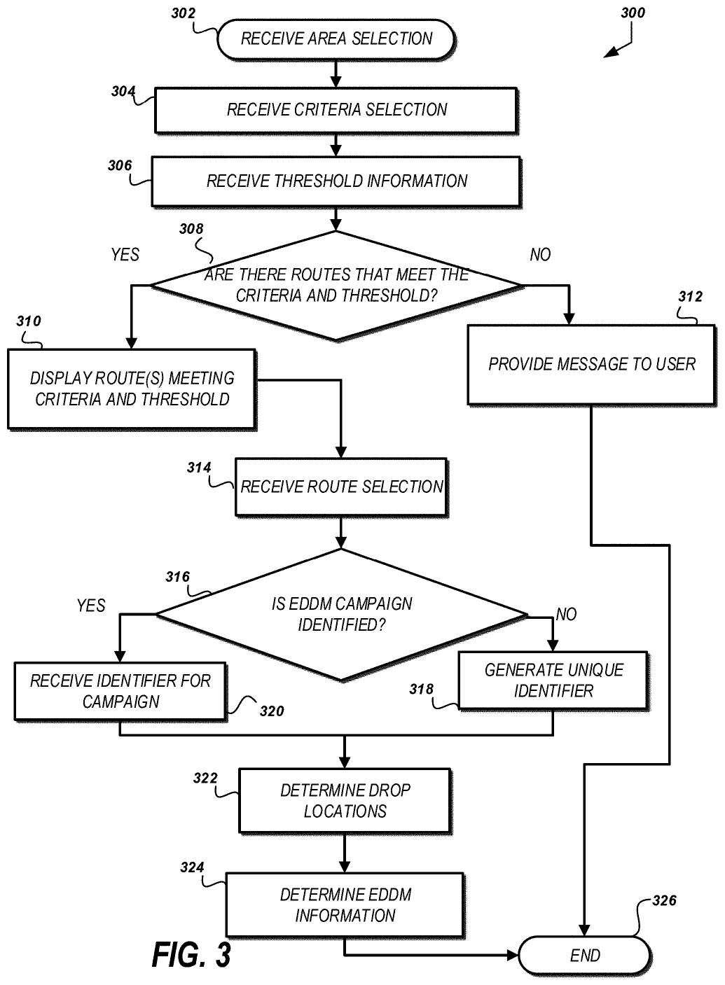

FIG. 3 is a flow chart illustrating an exemplary method for preparing saturation items for distribution. A process 300 begins in step 302, wherein a request for or a selection of a geographic area is received in a user interface such as the user interface 230. The mailer or sender, accessing the user interface, inputs a geographic area or area identifier in the search field 232. The geographic area can be any desired area, a selection of a map, an area code, a ZIP code, a city, town, county, or any other desired area. When the area is selected, the user interface 230 can display an interactive map of the selected area. In some embodiments, one or more areas can be selected, and the processes described herein can be performed for more than one area.

The process 300 moves to step 304, wherein the mailer or shipper provides and the system receives criteria selection 304. The selection criteria can be selected and input by the shipper or mailer, can be selected from provided categories, or can be a mix of both. The selection criteria can be demographic information, preference information, etc., for delivery points along routes in the selected area. For example, if the mailer wishes to send EDDM with marketing or information about luxury vehicles, the demographic information requested can include an average income above $100 k/year, those who own their home, those who have purchased a car in a given time frame, etc. In some embodiments, selection criteria need not be input prior to proceeding with the process 300. That is, routes can be selected to receive saturation items or EDDM without preselecting criteria.

In some embodiments, the distribution network provides a recipient a list of item that are intended for delivery to the recipient at a given time or date, such as on the day, one day in advance, two days in advance, or any other desired periodicity. In some embodiments, the distribution network can provide an identification of items for delivery to a recipient on the morning of the day the items will be delivered. In some embodiments, the identification includes a photograph or digital representation of the item for delivery. Such systems and delivery notification can be like those described in U.S. application Ser. No. 15/912,360, entitled “SYSTEM AND METHOD OF PROVIDING INFORMED DELIVERY ITEMS USING A HYBRID-DIGITAL MAILBOX, filed Mar. 5, 2018, the entire contents of which are hereby incorporated by reference.

In the case of EDDM, the system 100 does not have an image of the actual mailpiece that will arrive at the delivery point which was taken as mailpieces are scanned and imaged on the item processing equipment 140, because the EDDM mailpieces do not have a specific address associated with them. Thus, there may be no image of the specific physical piece of EDDM that will be delivered to a given delivery point. In this case, the system 100 can, on the in-house date, pull the sample piece, or the image of the sample piece, and provide the sample image to the recipient in a notification.

The process 300 moves to step 306, wherein the user interface 230 receives threshold information. The threshold can be a percent or quantity of delivery points on a route which meet the selection criteria. For example, the mailer or sender may request a percent threshold of 80%. In some embodiments, a threshold requirement may not be input, and this step can be omitted.

The process 300 moves to decision state 308, wherein the system hub 110 determines whether there are routes within the selected area that meet the criteria at the received threshold. The system hub 110 can query the delivery point database 122 and the route database 124 to identify routes with the selection criteria and the threshold. To make the determination regarding which delivery points meet the percent threshold, the system hub 110 queries the delivery point database 122 using the criteria, preferences, attributes, etc., provided by the sender or mailer. The system hub 110 identifies or receives a list of delivery points which are associated with the criteria, preferences, attributes, etc. The system hub 110 can cross reference the list of delivery points with the route database 124 to identify which routes have a threshold percent of delivery points that meet the criteria, preferences, attributes, etc., provided by the sender or mailer. For example, the system hub 110 queries the delivery point database 122 and the route database 124 to identify routes on which 80% or more of the delivery points have an income above $100 k/year and where 80% of delivery points are owned by the occupant.

In some embodiments, a mailer or sender can request demographic information on a higher level than an individual route level. For example, a mailer may want to get a list of 3-digit ZIP codes or 5-digit ZIP codes which meet the demographic criteria, the preferences, or the attributes. The system hub 110 can receive the demographic information, and can, using the delivery point database 122 and the route database 124, determine which 3 or 5-digit ZIP codes meet the demographic information. For example, a regional retailer may want to send EDDM to a large number of addresses, but only to areas where 75%, or some other threshold, are located within a certain radius of a brick-and-mortar store of the regional retailer. The system hub 110 can access the information in the delivery point database 122 and the route database 124 to determine which 3-digit ZIP codes or 5-digit ZIP codes are within the threshold radius. In some embodiments, a mailer may desire to send a piece of EDDM to 5-digit ZIP codes which have a 50% threshold of car ownership, home ownership, outdoor sports preferences, or any other desired criteria or attribute. The system hub 110 can return a list of 5-digit ZIP codes in which 50% of the delivery points meet the threshold criteria.

If no routes meet the threshold criteria, the process 300 moves to state 312, wherein the system hub 110 sends a message to the user interface 230 to indicate that no routes meet the criteria.

If one or more routes meet the criteria and/or the threshold, the process 300 moves to step 310, wherein the user interface displays the routes which meet the criteria and/or the threshold. In some embodiments, the separate criteria can be displayed separately, and routes which meet both or all the criteria can be identified in the user interface 230. The request threshold can be varied, or can be supplied in given increments. That is, the interface 130 can provide result information for routes that meet a 50% threshold, routes that meet a 60% threshold, an 80% threshold, a 90% threshold, or any other desired threshold. The interface 130 can provide one or more of these set thresholds, and can provide an option for the user to select a percent threshold of the provided percent thresholds.

In some embodiments, the routes 233 are highlighted, or when rolled over or selected, the routes show the percent of delivery points which meet the selection criteria. In this way, the mailer or shipper can see the level at which routes in the selected area meet the selection criteria.

The process 300 moves to step 314, wherein the user interface receives a selection of one or more routes. In some embodiments, a user can hover a pointer over or click on or select a particular route and see demographic information or other information for that route. In some embodiments, when a route is selected, the system hub 110 can display attributes, preferences, demographic information relevant to the route. For example, if a route 233 is selected, the user interface 230 can display the selected criteria, other criteria, or a combination of both for the routes 233. In some embodiments, hovering over or clicking on a route 233 in the user interface 230 can show the demographic information, such as average annual income, an average age and can display the attributes for which that route has an 80% threshold. In some embodiments, hovering over or clicking on a route 233 in the user interface 230 can show preference or other information for the route based on the selection criteria. The user interface 230 can display routes, highlight routes, or otherwise indicate which routes meet the selection criteria at the provided threshold, or can provide information for each route in the selected area, and the percent of delivery points which meet one or more selection criteria. In some embodiments, hovering over a route or selecting a route may show that the route has an 80% threshold for hunting, fishing, cars, and golf. In some embodiments, another selected route 233 could have an 80% threshold for home electronics, food delivery, and higher education. It will be understood that these particular preferences or attributes are exemplary only. A route may have any of a plurality of attributes or preferences for which there is an 80% threshold. This can occur, for example, where selection criteria is or is not initially requested.

The mailer or shipper selects routes to receive the EDDM items by clicking or otherwise selecting the routes. The routes can be added to a cart, to an order, etc. in some embodiments, the mailer or shipper can select to deliver EDDM items to a route, but indicate that the EDDM items should only go to delivery points which meet the selection criteria. The mailer or shipper will not be shown which delivery points along the route meet the selection criteria, but the system hub 110 can identify which delivery points meet the criteria, and can identify and associate those delivery points with a particular order and/or EDDM item.

The system hub 110 can determine a cost for the EDDM campaign, or to deliver the items requested. The system hub 110 can calculate a cost per mailpiece based on the selected routes. The system hub 110 can use several factors in determining the cost, including mailpiece size, destination, type, saturation, the number of facilities that will process the mailpieces, the service requirements, etc. in some embodiments, the system hub 110 can use historical information from the analytics engine 160 as part of the determination of cost per EDDM mailpiece. The cost can also be based on the number of routes, the number of mailpieces, whether the EDDM pieces can be dropped at a facility with item processing equipment 140 to sort the EDDM mailpieces, whether the EDDM item is to go to each delivery point on a route or if only some delivery points should get the EDDM item, and the like. If the selected routes indicate that a regional distribution facility can accept the EDDM mailpieces to sort them into the regular mailstream in delivery sequence order, the system hub 110 can determine that the cost per mailpiece can be reduced, because carriers will not be required to manually case or insert the EDDM mailpieces into mail stack or mail trays.

A mailer or sender may also provide an “in-house date” or a desired delivery date. The desired delivery date is also used by the system hub 110 to determine where to drop the EDDM mailpieces, based on knowing how items flow through the distribution network. For example, if the desired delivery date is a few days away, the system hub 110 can indicate to the mailer that the mailpieces should be dropped at a facility farther upstream in the distribution network than if the delivery date is sooner. If the delivery date window is smaller, or if the items need to be “in-house” within one or two days of induction, the system hub 110 can instruct the mailer to drop the mailpieces at delivery facilities farther downstream, for example, at a plurality of post offices, so they can be in carriers' hands earlier without needing to be moved from a regional distribution facility to a unit delivery facility as part of the mailstream. The system hub 110 can take this into account when providing a cost estimate for the EDDM mailpieces.

The process 300 moves to decision state 316, wherein it is determined whether an EDDM campaign is identified. This occurs by determining whether there is an identifier, code, or the like associated with the saturation or EDDM campaign. The user interface 230 may receive an identifier for the campaign, such as a code that will be on the EDDM items for use in processing. In some embodiments, the user interface can receive an image of the EDDM item which can be used as an identifier to identify the EDDM piece by image recognition on the item processing equipment.

The mailer or sender can also upload a sample EDDM piece to the user interface 230. The sample EDDM piece can be an image or a copy of the EDDM mailpiece that will be dropped at a distribution facility and inducted into the distribution network. The sample piece can be an image, or the sample piece can provide a physical EDDM piece to the distribution network, which can then be imaged and uploaded the piece to the memory 120. The mailer or sender can also request a code, such as a computer readable code, which encodes a sender identifier, such as a mailer ID (MID) of the mailer or sender, a unique license plate or serial number, which can include or be associated with a particular EDDM mailing, and which encodes a delivery destination, such as a 5-digit ZIP code. An EDDM mailing can refer to a particular EDDM mailpiece which is to be delivered to a plurality of delivery points, or can be associated with an EDDM campaign which involves one or more pieces of EDDM. In some embodiments, the mailer or sender can provide such a code to the distribution network, which the system hub 110 can store and associate with the EDDM mailing. In some embodiments, the system hub 110 pulls the computer readable code from the sample piece uploaded by the mailer.

If the campaign is not identified, the process 300 moves to step 318, wherein the system hub 110 generates a unique identifier for the campaign. The unique identifier can be provided to the mailer or shipper such that it can be applied to the EDDM items. The identifier is stored in the memory 120 or other location such that it can be accessed by the item processing equipment 140.

If the campaign is identified, the process 300 moves to step 320, wherein the mailer or shipper provides the identifier for the campaign via the user interface. The identifier is stored in the memory 120 or other location such that it can be accessed by the item processing equipment 140.

The process 300 moves to step 322 wherein the system hub determines one or more drop locations for the saturation items or EDDM mailpieces. Based on the location of the routes, the system hub 110 determines where the EDDM mailpieces should be dropped for induction into the distribution network. The drop points can be local unit delivery facilities such as post offices in the case where there are a few routes within the same ZIP code, or when the routes are close together within a geographic area. If the selected routes are spread out over a larger area, or if there is a large number of routes, then the system hub 110 can query the route database 122 to determine the number of delivery points in the selected routes 233, to determine where nearby distribution facilities are and which facilities have what types of item processing equipment 140, and to determine that the EDDM mailpieces should be dropped at a number of locations, such as a number of post offices. The system hub 110 can also determine how many EDDM mailpieces should be dropped at each location in order to deliver the EDDM mailpieces most efficiently. In some embodiments, the system hub 110 can determine that the EDDM mailpieces should be dropped at one or more plants or regional distribution facilities. The system hub 110 can make this determination based on known route associations with regional distribution facilities, based on the location of sorting equipment at distribution facilities and the like. For example, the system hub 110 can make a determination of where to drop or provide EDDM mailpieces based on which distribution facilities have item processing equipment capable of sorting EDDM mailpieces into sequence order with other mailpieces.

Where several routes are selected within a region serviced by a particular regional distribution facility which has sortation equipment, such as sortation equipment that sorts items into delivery sequence order or walk sequence order, the system hub 110 can instruct the mailer to drop the EDDM mailpieces intended for the several routes at the regional distribution facility, and provide the number of mailpieces to be dropped there for delivery to the selected routes. In some cases, the selected routes may be serviced by different regional distribution facilities, and the system hub 110 can determine and instruct the mailer how many pieces should be dropped at the different regional facilities.

The process 300 moves to step 324, wherein the EDDM campaign information is stored. The EDDM campaign information can include the routes, delivery points, the mailer ID, the shipper ID, the unique identifier for the campaign, an image of the item, and the like. This information can be stored in the memory 120 or in another location, or the information can be stored across various systems.

The process 300 moves to step 326 and ends.

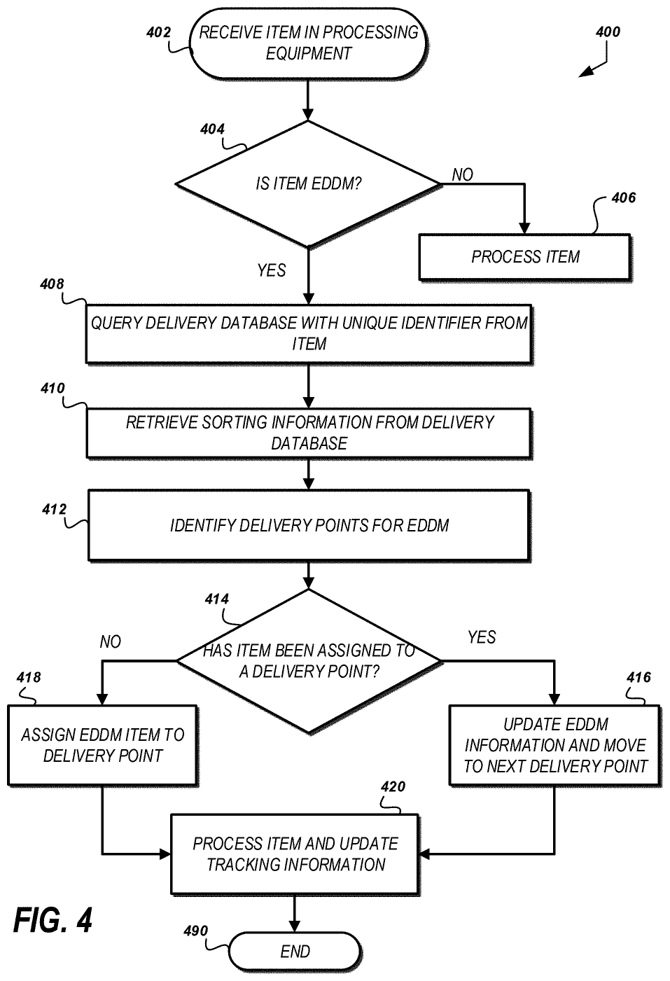

FIG. 4 is a flow chart illustrating an exemplary process for processing saturation items. A process 400 begins in step 402, wherein an item is received in item processing equipment 140. When EDDM mailpieces are dropped at distribution network facility and sortation will happen, the item processing equipment 140 can communicate with the system hub 110 to facilitate sorting an EDDM mailpiece to each destination, route, geographic area, etc., selected by the mailer or sender. When items are to be sorted for a route, plurality of routes, geographic area, etc., a tray or bin or pallet or container of identical EDDM items can be provided to the item processing equipment 140, in an induction area, in a tray, etc., along with the trays or bins or containers of other mailpieces to be sorted.

The EDDM mailpieces do not have specific delivery points identified on the physical mailpiece, but they can have an identifier, such as a computer readable code or other indicator thereon identifying an EDDM mailing. The system hub 110, or the memory 120, has stored an association between an EDDM mailing identifier and a plurality of routes, delivery points, geographic areas, etc. The system hub 110 has a record of which specific delivery points are to receive a particular EDDM mailing.

The process 400 moves to decision state 404, wherein the item processing equipment determines whether the item is EDDM. The system hub 110 can identify the item as EDDM by scanning a code on the item, by recognizing an identifier on the item, or by imaging the item and comparing the image of the item with images of EDDM stored in the memory. If the item is not identified as EDDM, the process 400 moves to step 406, and the item is processed like other non-EDDM items.

If the item is identified as an EDDM item, the process 400 moves to step 408, wherein the system hub 110 queries the memory 120 or other database where the EDDM information is stored.

The process 400 moves to step 410, wherein sorting or processing information is received from the memory 120 or other location where the EDDM route or campaign information is stored. The system hub 110 can identify a specific campaign for the item based on the identifier or computer readable code.

The process 400 moves to step 412, wherein the delivery points for the EDDM campaign are retrieved. The delivery points can be a list of all the delivery points along the routes selected for the EDDM mailing, or the delivery points can be a subset of delivery points along the route which meet the threshold criteria. The system hub 110 can create item records or delivery point records in the memory for tracking the delivery of the EDDM items.

The process 400 moves to step 414, wherein the system hub 110 determines whether a first delivery points for the identified EDDM campaign has been assigned an EDDM item. If there is no assigned EDDM item for the first delivery point, the process 400 moves to step 418, the system hub 110 assigns the scanned item to the first delivery point. This assignment can be a note, flag, update, or indication in the delivery point record that there has been an assigned item. The specifically scanned EDDM mailpiece does not have a delivery point on it, and is not uniquely identifiable as an individual piece, thus the specific item scanned may not end up being the specific EDDM mailpiece ultimately delivered to the delivery point.

To illustrate, when the item processing equipment 140 scans, images, reads, or identifies a piece of EDDM associated with a specific EDDM mailing, the system hub 110 assigns the piece of EDDM to one of the delivery points intended to receive the EDDM mailing, as selected by the sender or mailer on the user interface 230. The system hub 110 updates a record in the memory 120 to indicate that an EDDM mailpiece has been assigned to that delivery point.

The process 400 moves to step 420, wherein the item is processed and tracking information is updated. The item processing equipment 140 moves the EDDM mailpiece to a location, bin, stacker, etc. in the item processing equipment 140 associated with the delivery point to which the EDDM mailpiece was just assigned. The record is updated to prevent the item processing equipment 140 for routing another piece of EDDM associated with the same EDDM mailing to that delivery point.

If the item processing equipment is not sorting to delivery point level, the EDDM mailpiece can be moved to a location indicated for the route to which the delivery point belongs. These items may be sorted again at a finer sort level, such as when the items are sorted to delivery points at a different point in the distribution network.

When the first delivery point has been assigned an EDDM item, the process 400 moves to step 416, wherein the next delivery point is identified, and the process described in step 418 repeats for the next identified delivery point.

To illustrate, when the next piece of EDDM is scanned, the system hub 110 assigns that piece of EDDM to another one of the delivery points to which there has not previously been an EDDM mailpiece assigned. The process 400 moves to step 420, wherein the item is processed and tracking information is updated. The item processing equipment 140 moves the next EDDM mailpiece to the location, bin, stacker, etc. associated with the another one of the delivery points. The process continues, virtually assigning an EEDM mailpiece to each destination on the list of delivery points, moving the physical EDDM mailpieces to the proper locations for the delivery points.

In some embodiments the item processing equipment can employ a two-pass sorting scheme, similar to that described in U.S. patent application Ser. No. 16/151,983, filed Oct. 4, 2018, the entire contents of which are hereby incorporated by reference. In a two-pass sorting scheme, the EDDM mailpieces can be run at the end of pass 1, and sorted to stop groups according to the sorting scheme. In pass 1, the system hub 110 virtually assigns the physical EDDM pieces to the delivery points and ensures that only 1 EDDM mailpiece is assigned to each delivery point, as described above. In pass 2, the EDDM mailpieces are sorted to the individual delivery points and put in walk sequence order. When the trays from pass 2 are run on the item processing equipment 140, the system hub 110 again virtually assigns a physical EDDM to each delivery point within the stop group, or within whatever collection of delivery points are being run on the item processing equipment 140. This second virtual assignment, during pass 2, can be performed because a tray at the end of pass 1 has all the items for the collection of stop groups in that tray. Because the physical EDDM mailpieces do not have delivery points identified thereon, the system hub 110 can, on scanning on pass 2, assign the physical EDDM mailpieces to the plurality of delivery points, ensuring that only 1 physical EDDM mailpiece is assigned to a delivery point, and that 1 physical EDDM mailpiece is moved to the location, bin, stacker, etc., within the item processing equipment 140 associated with that delivery point.

The process 400 moves to step 490 and ends.

EDDM mailpieces and delivery of EDDM items can be tracked and analyzed by the distribution network. Distribution networks, such as USPS, may not scan EDDM mailpieces on induction or delivery, and since the EDDM mailpieces are not associated with any particular delivery point, determining when the EDDM is actually delivered can be difficult. The system hub 110 can provide logical handling events based on certain criteria. When a mailer or sender selects routes or geographic areas for delivery of EDDM mailpieces, the system 100 can create a record for the EDDM mailpiece for each delivery point in the selected route(s) or geographic area. When the EDDM mailpieces are dropped at the facilities, the pallet, container, or bulk stack can be scanned and inducted or accepted. When this occurs, the system 100 can determine that an induction event has occurred for each individual EDDM mailpiece and the induction scan event can be recorded in the record for each delivery point.

A delivery scan event can be logically created at the beginning or end of the in-house date, with the system 100 assuming that the item was delivered on the in-house date. In some embodiments, the system hub 110 can receive information from the carrier database 150 regarding the completion of a route, the entry and/or exit from a geofence around a delivery point, and the like. In some embodiments, the carrier database 150 or the system hub 110 can identify when the carrier has delivered one other item which was scanned to a delivery point along the route with which the EDDM mailpiece is associated. When one item has been delivered to a delivery point along the route, the system hub 110 can determine or that the EDDM items for that route have been delivered. When the system 100 receives this information, the system 100 can create a logical handling event which assumes that since the carrier entered and exited a geo-fence around a delivery point for which an EDDM mailpiece was to be delivered, that the EDDM mailpiece for that delivery point was delivered by the carrier. In some embodiments, the system hub 110 can generate a logical handling event, such as an out-for-delivery event, or any other scan event based on information from the carrier database 150. For instance, when a carrier who has EDDM mailpieces for a route departs the distribution network facility (as indicated by geolocation information from the carrier's vehicle, mobile delivery device, etc.), the system hub 110 can create an out-for-delivery event for each piece of EDDM along the route.

In some embodiments, as noted above, the EDDM campaign may not be delivered to every delivery point on a route, but may be delivered to a subset of the delivery points which meet the criteria. In this case, the item processing equipment 140 cannot just assign an EDDM mailpiece to each delivery point, but must sort EDDM mailpieces only to those delivery points which meet the criteria, or which have been put on the list of delivery points for the EDDM. The system hub 110 can select a plurality or list of delivery points within geographic areas and/or routes which do not necessarily include all delivery points along a route. The system hub 110 can make these determinations based on the demographic information using information from the route database 124 and the delivery point database 122.

For example, the EDDM mailpiece may be an advertisement for lawn care. The mailer or sender provided the category of lawn care or similar category to the user interface 230. The system hub 110 identified delivery points within a route or a geographic area which meet that criteria, such as at an 80% threshold. However, the delivery point database 122 knows which delivery points of the selected routes 233 do not meet the 80% threshold. The system hub 110 using the route database 124 can tell the mailer or sender the number of mailpieces to be dropped or provided to the distribution facility, corresponding to only those delivery points which are indicated as being associated with the category, lawn care. In some embodiments, the system hub 110 will not provide the specific list of delivery points which meet or do not meet the criteria, but can give only a number of EDDM mailpieces needed.

For example, the system hub 110 can determine that delivery points in an apartment building do not meet the demographic information for lawn care, as they do not have lawns to care for. The system hub 110 can exclude these delivery points along the route from the list of delivery points to which the EDDM mailpiece will be sent.

During sortation on the item processing equipment, since EDDM mailpieces do not have individual delivery point information thereon, the EDDM cannot be sorted only to addresses which are included for the EDDM mailing. During sortation, when an EDDM mailing is scanned, the item processing equipment 140 and/or the system hub 110 can virtually assign the EDDM mailpiece to one of the delivery points included in the EDDM mailing, and the item processing equipment 140 can move the physical EDDM mailpieces only to those bins, stackers, etc., which are assigned to delivery points which are to receive EDDM mailpieces.

In some embodiments, when sorting and routing EDDM mailpieces together with regular mail items, and an EDDM mailpiece is scanned, the system hub 110 can determine the destination for the immediately preceding scanned item and cross-reference that destination with the list of delivery points intended to receive the EDDM mailing. If the delivery point for the immediately preceding item is to receive an EDDM mailpiece for the EDDM mailing, then the item processing equipment 140 routes the EDDM mailpiece to the delivery point to which the immediately preceding mailpiece was routed. If the delivery point of the preceding item is not on the list to receive the EDDM mailpiece, the system hub 110 can instruct the item processing equipment to hold the EDDM mailpiece, route it to another location, such as an overflow or reject location, or can route it to another bin or stacker for a delivery point which is intended to receive the EDDM mailing and which has not already been assigned an EDDM mailpiece. In some embodiments, the EDDM mailpieces sent to the overflow or reject location can be reinserted into the item processing equipment 140 and run again and be sorted as described herein.

In some embodiments, the EDDM is not sorted into delivery sequence order on item processing equipment 140 but is provided in bulk to a carrier at the unit delivery facility. In the case where the EDDM mailpiece is to be delivered to only a subset of delivery points along a delivery route, the system hub 110 can inform the carrier database 150 when a carrier is within a geofence of a delivery point to which the EDDM mailpiece is to be delivered. In some embodiments, the system hub 110 can send the list of delivery points to which the EDDM mailpiece is to be delivered to the carrier's mobile delivery device, for example, via the carrier database 150. As a carrier traverses a route, when the carrier enters and/or approaches a delivery point to which an EDDM mailpiece should be delivered, the mobile delivery device can provide an alert to the carrier to tell the carrier to put one of the EDDM mailpieces in the mailbox along with other distribution items.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the development should not be taken to imply that the terminology is being re-defined herein to be restricted to including any specific characteristics of the features or aspects of the technology with which that terminology is associated.

The technology is operational with numerous other general purpose or special purpose computing system environments or configurations. Examples of well-known computing systems, environments, and/or configurations that may be suitable for use with the development include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A microprocessor may be any conventional general purpose single- or multi-chip microprocessor. In addition, the microprocessor may be any conventional special purpose microprocessor such as a digital signal processor or a graphics processor. The microprocessor typically has conventional address lines, conventional data lines, and one or more conventional control lines.

The system may be used in connection with various operating systems such as Linux®, UNIX® or Microsoft Windows®.

The system control may be written in any conventional programming language such as and ran under a conventional operating system. For example, any industry standard programming languages for which many commercial compilers can be used to create executable code may be used. The system control may also be written using interpreted languages.

Those of skill will further recognize that the various illustrative logical blocks, modules, circuits, and algorithm steps described in connection with the embodiments disclosed herein may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the present development.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the development should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, un-recited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present development. At the very least, and not as an attempt to limit the application of the doctrine of equivalents to the scope of the claims, each numerical parameter should be construed in light of the number of significant digits and ordinary rounding approaches.

The above description discloses several methods and materials of the present development. This development is susceptible to modifications in the methods and materials, as well as alterations in the fabrication methods and equipment. Such modifications will become apparent to those skilled in the art from a consideration of this disclosure or practice of the development disclosed herein. Consequently, it is not intended that this development be limited to the specific embodiments disclosed herein, but that it cover all modifications and alternatives coming within the true scope and spirit of the development as embodied in the attached claims.

What is claimed is:

1. A method for processing items, the method comprising:
receiving, via a user interface, information identifying a campaign for distributing a plurality of items;
receiving, via the user interface, an indication of a geographic area to which the plurality of items will be delivered;
receiving, via the user interface, one or more selection criteria;
determining one or more delivery routes within the geographic area which meet the one or more selection criteria;
receiving a selection a plurality of delivery points from the one or more delivery routes to receive the plurality of items;
storing the selected plurality of delivery points;
receiving, in item processing equipment, one of the plurality of items;
scanning, in the item processing equipment, the one of the plurality of items to identify the one of the plurality of items as being associated with the campaign;
identify one of the selected plurality delivery points to receive the one of the plurality of items;
sorting, in the item processing equipment, the one of the plurality of items according to the identified one of the plurality of delivery points; and
updating tracking information for the stored selected plurality of delivery points.

2. The method of claim 1, wherein the plurality of items are identically addressed.

3. The method of claim 1, wherein the plurality of items do not have individual delivery points indicated thereon.

4. The method of claim 1, further comprising receiving, via the user interface, a threshold value for the one or more selection criteria.

5. The method of claim 1, further comprising generating a unique identifier to identify the plurality of items of the campaign.

6. The method of claim 5, wherein scanning the one of the plurality of items to identify the one of the plurality of items as being associated with the campaign comprises reading the unique identifier from the received one of the plurality of items.

7. The method of claim 1, further comprising, determining, in a processor, a drop location for the plurality items.

8. The method of claim 7, wherein the drop location is a facility where a sender of the plurality of items physically provides the plurality of items to be inducted into a distribution network.

9. The method of claim 7, wherein determining a drop location comprises determining a plurality of drop locations based on the selected geographic area and the determined one or more delivery routes.

10. The method of claim 1, further comprising displaying, via the user interface, the determined one or more delivery routes

11. The method of claim 1, wherein the selected plurality of delivery points from the one or more delivery routes include each delivery point for each of the one or more delivery routes.

12. The method of claim 1, wherein the selected plurality of delivery points from the one or more delivery routes include only a subset of delivery points from each of the one or more delivery routes.

13. A method for securing a receptacle, the method comprising:
receiving, in a processor, campaign information for distribution of a plurality of items, the campaign information including a plurality of delivery points to receive the plurality of items of the campaign;
receiving, in item processing equipment, one of the plurality of items;
scanning, in the item processing equipment, the one of the plurality of items to identify the one of the plurality of items as being associated with the campaign;
identifying, by a processor, one of the plurality of delivery points from the campaign information;
assigning, in a memory, the scanned item to the identified one of the plurality of delivery points;
moving, in the item processing equipment, the scanned item to a sort location according to the assigned delivery point; and
updating a tracking record for the campaign information based on the moving the scanned item to the sort location according to the assigned delivery point.

14. The method of claim 13, wherein the campaign information includes delivery point records for each delivery point of the plurality of delivery points.

15. The method of claim 14, wherein updating a tracking record for the campaign information comprises updating the delivery point record to indicate that the scanned item of the plurality of items has been assigned to the delivery point.

16. The method of claim 13, wherein the plurality of items are identically addressed.

17. The method of claim 13, wherein the plurality of items do not have individual delivery points indicated thereon

18. A method for processing items, the method comprising:
a server configured to:
receive, via a user interface, information identifying a campaign for distributing a plurality of items;
receive, via the user interface, an indication of a geographic area to which the plurality of items will be delivered;
receive, via the user interface, one or more selection criteria;
determine one or more delivery routes within the geographic area which meet the one or more selection criteria;
display, via the user interface, the one or more delivery routes which meet the one or more selection criteria;
receive, via the user interface, a selection a plurality of delivery points from the one or more delivery routes to receive the plurality of items; and
store the selected plurality of delivery points;
item processing equipment configured to:
receive, in item processing equipment, one of the plurality of items;
scan, in the item processing equipment, the one of the plurality of items to identify the one of the plurality of items as being associated with the campaign;
identify one of the selected plurality delivery points to receive the one of the plurality of items; and
sort the one of the plurality of items according to the identified one of the plurality of delivery points.

19. The system of claim 18, wherein the plurality of items are not individually addressed.
